(19) United States
(12) Patent Application Publication
(10) Pub. No.: US 2010/0161367 A1
(43) Pub. Date: Jun. 24, 2010

(54) Customizing Online Calendar Entries

(76) Inventors: Susann M. Keohane, Austin, TX (US); Gerald F. Mcbrearty, Austin, TX (US); Shawm P. Mullen, Buda, TX (US); Jessica C. Murillo, Round Rock, TX (US); Johnny M. Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 12/341,153

(22) Filed: Dec. 22, 2008

(51) Int. Cl. G06Q 10/00

(52) U.S. Cl. 705/8

(57) ABSTRACT

Disclosed is a method for customizing online calendar entries. A contact list for an online calendar is created including individuals and groups. An exception list is created from the individuals and/or groups on the contact list. When an online invitation is created, but not yet sent, conflict resolution tools allow the creator of the invitation to check all invitee's calendar entries for potential conflicts. A conflict resolution tool checks the calendar of an invitee for potential availability of a time corresponding to an open time slot. A conflict resolution tool responds to the online invitation with an acceptance response. A user can customize the acceptance response. The customized acceptance response is linked to the exception list. If a subsequent online invitation is received from an individual or group member on the exception list during the blocked time slot, the blocked time slot is detected as open, and scheduling of events during the blocked time slot is allowed.

### BACKGROUND

1. Technical Field

The present invention generally relates to computer systems and in particular to customizing online calendar entries to allow conflict exceptions in the calendar entries.

2. Description of the Related Art

While online calendaring and online tools become part of the daily business environment, some customization or special condition features tend to be unavailable to a user. Current art methods of calendaring do not allow a first user to schedule an event with a second user during a time slot that appears as “blocked” for either the first or the second user. For example, when attempting to schedule a meeting online, a conflict resolution tool is used to determine whether a first user and a second user have a calendar opening for a certain time slot. Currently, the conflict resolution tool cannot schedule a meeting for the first user with the second user during Jul. 1, 2008 at noon, for example, if the second user has a “blocked” time slot for Jul. 1, 2008 at noon. The Jul. 1, 2008 noon time slot for the second user may have been a placeholder for a meeting the second user typically does not attend. In such a case, the second user currently has no option of allowing a conflict resolution tool to accept an invitation for meeting with the first user during the blocked Jul. 1, 2008 noon time slot.

### SUMMARY OF ILLUSTRATIVE EMBODIMENTS

Disclosed is a method for customizing online calendar entries. A contact list for an online calendar is created including individuals and groups. An exception list is created from the individuals and/or groups on the contact list. When an online invitation is created, but not yet sent, conflict resolution tools allow the creator of the invitation to check all invitee's calendar entries for potential conflicts. A conflict resolution tool checks the calendar of an invitee for potential availability of a time corresponding to an open time slot. A conflict resolution tool responds to the online invitation with an acceptance response. A user can customize the acceptance response. The customized acceptance response is linked to the exception list. If a subsequent online invitation is received from an individual or group member on the exception list during the blocked time slot, the blocked time slot is detected as open, and scheduling of events during the blocked time slot is allowed.

The above as well as additional features and advantages of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 is a block diagram of a data processing system configured with hardware and software components for implementing one or more embodiments of the invention;

FIG. 2 illustrates an example of an online calendar database, in accordance with one embodiment of the invention;

FIG. 3 illustrates an example of an online calendar, in accordance with one embodiment of the invention; and

FIG. 4 is a flow chart of the process by which the features of the invention are implemented, according to one embodiment of the invention.

### DETAILED DESCRIPTION OF AN ILLUSTRATIVE EMBODIMENT

The illustrative embodiments provide a method, a system and a computer program product for customizing online calendar entries. A contact list for an online calendar is created including individuals and groups. An exception list is created from the individuals and/or groups on the contact list. When an online invitation is created, but not yet sent, conflict resolution tools allow the creator of the invitation to check all invitee's calendar entries for potential conflicts. A conflict resolution tool checks the calendar of an invitee for potential availability of a time corresponding to an open time slot. A conflict resolution tool responds to the online invitation with an acceptance response. A user can customize the acceptance response. The customized acceptance response is linked to the exception list. If a subsequent online invitation is received from an individual or group member on the exception list during the blocked time slot, the blocked time slot is detected as open, and scheduling of events during the blocked time slot is allowed.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

Within the descriptions of the figures, similar elements are provided similar names and reference numerals as those of the previous figure(s). Where a later figure utilizes the element in a different context or with different functionality, the element is provided a different leading numeral representative of the figure number. The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized.

With reference now to the figures, FIG. 1 depicts a block diagram representation of a data processing system (and connected network). DPS 100 comprises at least one processor or central processing unit (CPU) 105 connected to system memory 106 via system interconnect/bus 110. System memory 106 is defined as a lowest level of volatile memory, including, but not limited to, cache memory, registers, and buffers. Also connected to system bus 110 is I/O controller 120, which provides connectivity and control for input devices, of which pointing device (or mouse) 125 and keyboard 127 are illustrated, and output devices, of which display 129 is illustrated. Additionally, a multimedia drive 128 (e.g., CDRW or DVD drive) and USB (universal serial bus) port 126 are illustrated, coupled to I/O controller 120. Multimedia drive 28 and USB port 126 may operate as both input and output (storage) mechanisms. DPS 100 also comprises storage 117, within which data/instructions/code may be stored.

DPS 100 is also illustrated with network interface device (NID) 150 coupled to system bus 110. NID 150 enables DPS 100 to connect to one or more access networks 170, such as the Internet.

Notably, in addition to the above described hardware components of DPS 100, various features of the invention are completed via software (or firmware) code or logic stored within memory 106 or other storage (e.g., storage 117) and executed by CPU 105. In one embodiment, data/instructions/code from storage 117 populates the system memory 106, which is also coupled to system bus 110. Thus, illustrated within memory 106 are a number of software/firmware components, including operating system (OS) 130 (e.g., Microsoft Windows®, a trademark of Microsoft Corp, or GNU®/Linux®, registered trademarks of the Free Software Foundation and The Linux Mark Institute, or Advanced Interactive eXecutive—AIX, registered trademark of International Business Machines—IBM), calendaring/scheduling applications 135, and Customizing Calendar Entries (CCE) utility 140. An online calendar can be viewed on a display 129 of the DPS 100.

In actual implementation, calendaring/scheduling applications 135 and CCE utility 140 may be combined as a single application collectively providing the various functions of each individual software component when the corresponding code is executed by the CPU 105. For simplicity, CCE utility 140 is illustrated and described as a stand alone or separate software/firmware component, which is stored in system memory 106 to provide/support the specific novel functions described herein.

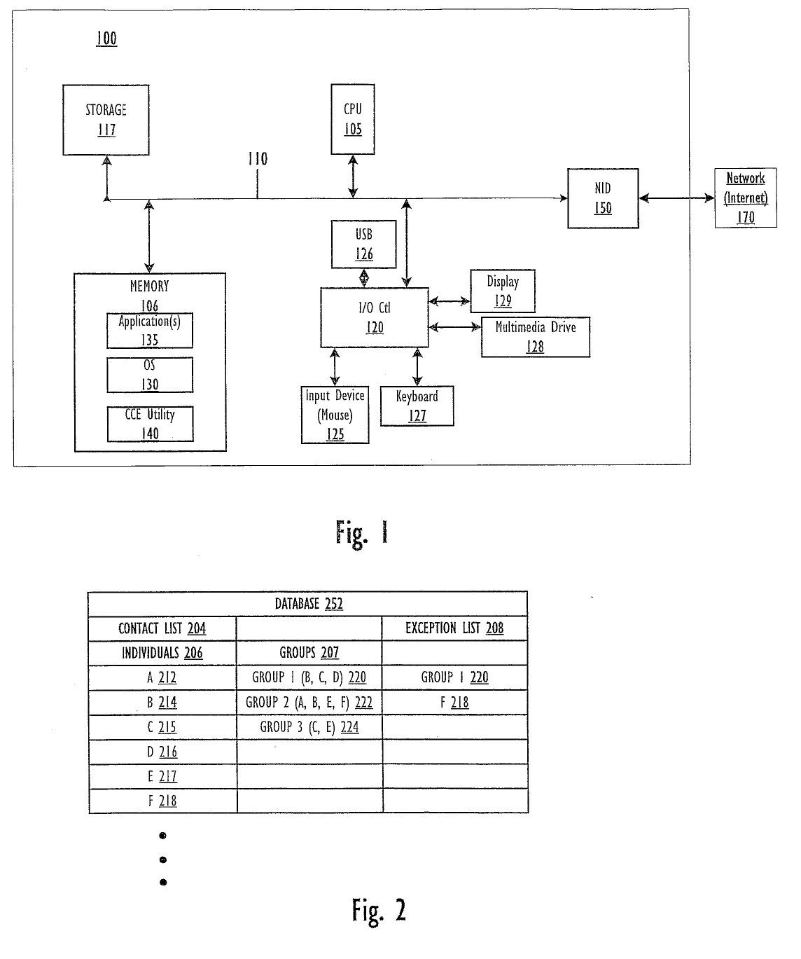

CPU 105 executes calendaring/scheduling applications 135 along with CCE utility 140 as well as OS 130, which supports the user interface features of CCE utility 140. In the illustrative embodiment, CCE utility 140 generates/provides several graphical user interfaces (GUI) to enable user interaction with, or manipulation of, the functional features of the utility (140). Among the software code/instructions provided by CCE utility 140, and which are specific to the invention, are: (a) code for creating a contact list of individuals and groups for an online calendar; (b) code for creating an exception list including one or more individuals and groups from the contact list; (c) code for receiving a first online invitation; (d) code for responding by a conflict resolution tool to the first online invitation with an acceptance response; (e) code for customizing the acceptance response; (f) code for linking the customized acceptance response to the exception list; (g) code for blocking the time slot corresponding to the first online invitation; (h) code for receiving a second online invitation for the blocked time slot corresponding to the first online invitation; (i) code for determining, by the conflict resolution tool, an availability for scheduling an event during the blocked time slot; (j) code for: if the second online invitation is received from a member of the exception list, handling the blocked time slot as an open time slot with respect to the member of the exception list; (k) code for preventing the scheduling of the second online invitation during the blocked time slot for each subsequent online invitation for scheduling events during the blocked time slot, when the subsequent online invitation is received from individuals and group members that are not included on the exception list; (l) code for displaying a customized message to one or more members of the exception list when the time slot is blocked; (m) code for displaying the online calendar wherein details of the online calendar are displayed to members of the exception list; and (n) code for dynamically updating the online calendar when scheduling of events are received. For simplicity of the description, the collective body of code that enables these various features is referred to herein as CCE utility 140. According to the illustrative embodiment, when CPU 105 executes CCE utility 140, DPS 100 initiates a series of functional processes that enable the above functional features as well as additional features/functionality, which are described below within the description of FIGS. 2-4.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention. The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

With reference now to FIG. 2, an example of an online calendar database 252 is shown. A contact list 204 is created by adding individuals 206 and groups 207 to the online calendar database 252. In FIG. 2, a user has added individuals A 212, B 214, C 215, D 216, E 217, and F 218 to the individuals portion 206 of the contact list 204. The user has added group 1 220, group 2 222, and group 3 224 to the groups portion 207 of the contact list 204. Group 1 220 consists of individuals B 214, C 215, and D 216. As an example, group 1 220 is the user's lunch group. Group 2 222 includes individuals A 212, B, 214, E 217, and F 218, and may be the user's committee meeting group. Group 3 224 includes individuals C 215 and E 217, and is the user's manager chain, i.e. the user's first and second line managers.

An exception list 208 is created by adding individuals 206 and/or groups 207 from the contact list 204 to the exception list 208. In FIG. 2, the user has added group 1 220 and individual F 218 to the exception list 208. When a conflict resolution tool responds to an online invitation with an acceptance response, the user can customize the acceptance response. The customized acceptance response is linked to the exception list 208. A customized acceptance response may be an option or button for the user to select that states “Accept-Allow supersedes”, or some similar option. A sender of the online invitation is unaware that the response is a customized acceptance response, and receives an affirmative response to the invitation. In an alternate embodiment, the sender of the online invitation is aware that the affirmative response from the user is a customized acceptance response, and that the user may not ultimately attend the event if another event is subsequently scheduled for the same time slot which the user would rather attend.

For example, the user customizes an acceptance response to a recurring invitation that is sent in mass to over 300 people for a brownbag lunch meeting. Based upon past experience, the user knows the brownbag lunch meetings usually feature speakers and topics that are of little interest to the user. However, the user would like to attend the brownbag lunch meeting if there are no other events occurring during the time for the brownbag lunch meeting. The user would like the option of subsequently receiving other invitations from the user's lunch group, i.e. group 1 220, or other individuals, i.e. individual F 218, for the same time slot so that the user may consider changing the user's schedule to instead attend an event with the user's lunch group or other individuals specified on the exception list 208. The user customizes the acceptance response to the brownbag lunch meeting. The customized acceptance response is linked to the user's exception list 208. The user's exception list 208 includes the user's lunch group, i.e. group 1 220, and individual F 218 that the user would rather have lunch with during the time slot for the brownbag lunch meeting, should the opportunity present itself. If the lunch group, i.e. group 1 220, or individual F 218, sends an invitation to the user for the time slot of the brownbag lunch meeting, a conflict resolution tool will determine that the user is available for the time slot. The conflict resolution tool will detect an open time slot and allow members of group 1 220 or individual F 218 to schedule a meeting during the time slot. Scheduling for the lunch is then allowed for members of group 1 220 or individual F 218. A blocked time slot will be detected for all others who are not on the exception list for the time slot of the brownbag lunch meeting.

In one embodiment of the invention, a customized message is displayed to member of the exception list 208 when the members of the exception list 208 send an online invitation to the user for a time slot that is blocked. The customized message, for example, may be a pop-up message that states “I can attend an event for 30 minutes or less”. The customized message could be presented when a conflict resolution tool determines the user is available, but before an invitation is sent by the member of the exception list 208, to allow the member of the exception list 208 to determine whether to send an invitation to the user. In one embodiment, details of the user's calendar entry which is linked to the exception list 208 are displayed to members of the exception list 208.

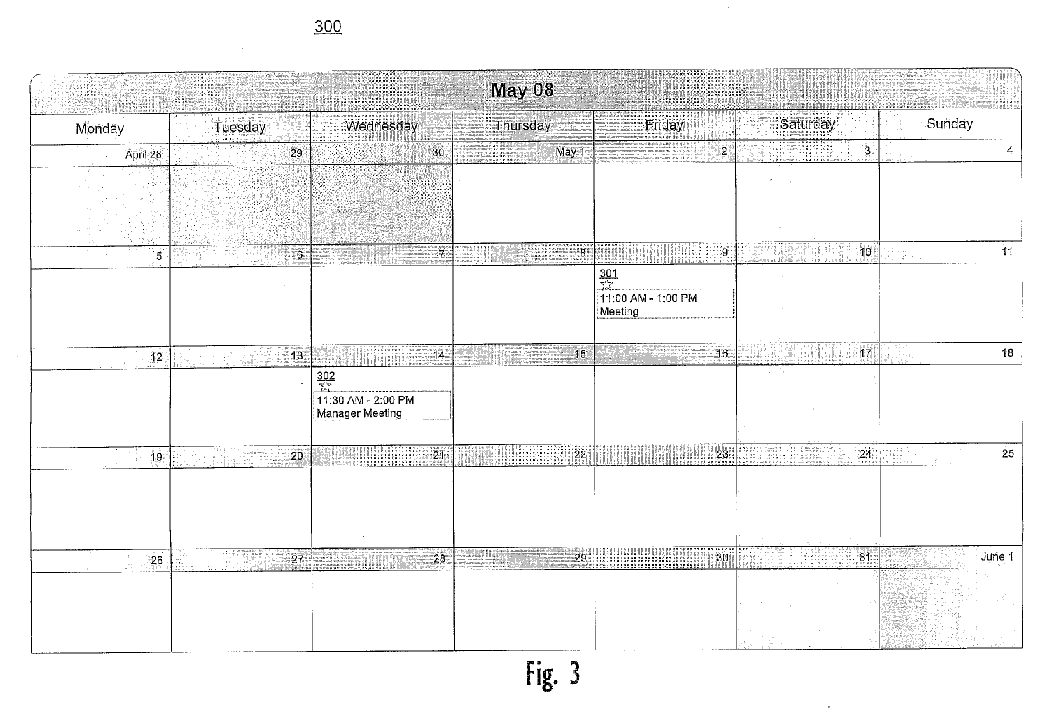

FIG. 3 shows an example of one month of an online calendar 300. An acceptance response is customized for a May 9, 2008 online calendar entry 301 on the online calendar 300. The May 9, 2008 online calendar entry 301 is for a brownbag lunch meeting. The user would like to attend the brownbag lunch meeting if no other options subsequently become available with members of the user's exception list. If a member of the user's exception list sends an invitation for the blocked time slot of the May 9, 2008 online calendar entry 301, an open time slot is detected by the conflict resolution tool, and the member is allowed to schedule an event with the user during the blocked time slot. A blocked time slot will be detected by the conflict resolution tool for all other calendar users attempting to schedule an event during the blocked time slot on May 9, 2008.

A May 14, 2008 calendar entry 302 in FIG. 3 is for a mandatory manager meeting and has not been linked to the user's exception list. If members of the user's exception list send an invitation to schedule an event for the blocked time slot on May 14, 2008, a blocked time slot will be detected by the conflict resolution tool for exception list members, and the event will not be scheduled. A blocked time slot will also be detected for all other calendar users sending invitations to schedule an event during the blocked time slot on May 14, 2008.

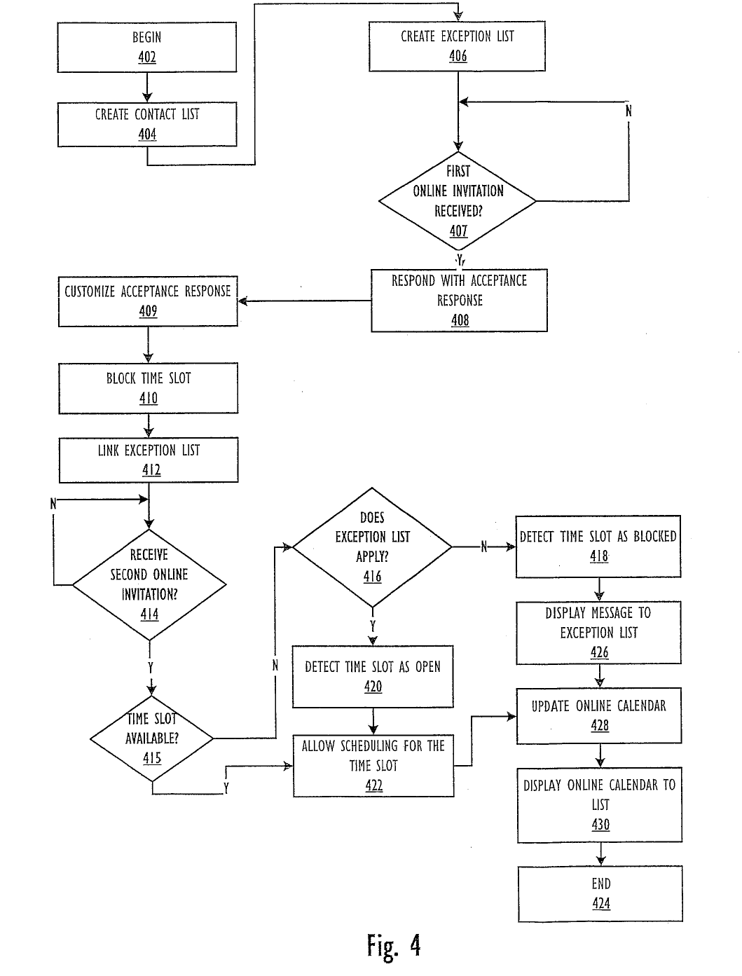

FIG. 4 is a flow chart illustrating one method by which the above process of the illustrative embodiments is completed. Although the method illustrated in FIG. 4 may be described with reference to components shown in FIG. 1, it should be understood that this is merely for convenience and alternative components and/or configurations thereof can be employed when implementing the method. Key portions of the method may be completed by CCE utility 140 executing within DPS 100 (FIG. 1) and controlling specific operations of/on DPS 100, and the methods are thus described from the perspective of either/both CCE utility 140 and DPS 100.

The process of FIG. 4 begins at initiator block 402 and proceeds to block 404, at which a contact list is created by adding individuals and groups to an online calendar, block 404. An exception list is created by adding one or more individuals and/or groups from the contact list to the exception list, block 406. A determination is made regarding whether a first online invitation has been received for an open time slot, block 407. If an online invitation has not been received, the process waits until an online invitation has been received before proceeding. If an online invitation has been received for an open time slot, a conflict resolution tool responds with an acceptance to the invitation 408. A user can customize the acceptance response, block 409. A corresponding time slot for the first online invitation is blocked on the user's online calendar, block 410. The customized acceptance response is linked to the user's exception list, block 412.

A determination is made regarding whether a second online invitation has been received, block 414. If a second online invitation has not been received, the process waits until a second online invitation is received before proceeding. If a second online invitation has been received, a conflict resolution tool determines whether the user is available for the time slot corresponding to the second online invitation, block 415, by using a conflict resolution tool. If the user is available for the time slot corresponding to the second online invitation, scheduling for the time slot is allowed, block 422, and the process ends, block 424. If the user is unavailable for the time slot corresponding to the second online invitation, a determination is made regarding whether the user's exception list applies, block 416, i.e. whether the sender of the second online invitation is a member of the user's exception list. If the sender of the second online invitation is not a member of the user's exception list, the time slot corresponding to the time slot of the second online invitation is detected as a blocked time slot, block 418, and the process ends, block 424. If the sender of the second online invitation is a member of the user's exception list, the time slot corresponding to the second online invitation is detected as open, block 420. Scheduling is allowed for the time slot, block 422. The online calendar is updated, block 428, and the process ends, block 424.

In an alternate embodiment, a customized message is provided to members of the exception list (block 426). The customized message could be a pop-up message displayed to the members of the exception list. The customized message could inform the members that the user is only available for a portion of the event during which the exception list members are sending an invitation. In one embodiment, the customized message is provided to the exception list members prior to an invitation being sent, to allow the exception list members to determine whether to schedule an event and send invitations. In one embodiment, exception list members are allowed to view details of the user's online calendar entry for which the exception list is linked (block 430).

In the flow chart above, one method is embodied in a computer readable medium containing computer readable code such that a series of steps are performed when the computer readable code is executed on a computing device. In some implementations, certain steps of the method are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The method of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. By way of example, a non exclusive list of types of media includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method for customizing online calendar entries, comprising:
creating a contact list of individuals and groups for an online calendar, wherein the online calendar is displayed online;
creating an exception list including one or more individuals and groups from the contact list;
receiving a first online invitation;
responding, by a conflict resolution tool, to the first online invitation with an acceptance response when (a) the first online invitation does not request scheduling an event at a time which is already blocked out for a previously-scheduled event or (b) the first online invitation is received from a member of the exception list;
customizing the acceptance response;
linking the customized acceptance response to the exception list;
blocking the time slot corresponding to the first online invitation;
allowing scheduling of events for members of the exception list during the blocked time slot;
receiving a second online invitation for the blocked time slot corresponding to the first online invitation;
determining, by the conflict resolution tool, an availability for scheduling an event during the blocked time slot;
if the second online invitation is received from a member of the exception list, handling the blocked time slot as an open time slot with respect to the member of the exception list;
preventing the scheduling of the second online invitation during the blocked time slot for each subsequent online invitation for scheduling events during the blocked time slot, when the subsequent online invitation is received from individuals and group members that are not included on the exception list;
displaying a customized message to one or more members of the exception list when the time slot is blocked;
displaying the online calendar wherein details of the online calendar are displayed to members of the exception list; and
dynamically updating the online calendar when scheduling of events are received.
